(19) United States
(12) Patent Application Publication
(10) Pub. No.: US 2026/0129420 A1
(43) Pub. Date: May 7, 2026

(54) ENERGIZING AND SCANNING PATTERNS FOR ENERGIZING RF BATTERY-LESS TAGS

(71) Applicant: Samsung Electronics Co., Ltd., Suwon-si (KR)

(72) Inventors: Vishnu Vardhan Ratnam, Frisco, TX (US); Boon Loong Ng, Plano, TX (US); Abhishek Sehgal, Frisco, TX (US)

(21) Appl. No.: 19/380,758

(22) Filed: Nov. 5, 2025

Related U.S. Application Data
(60) Provisional application No. 63/717,141, filed on Nov. 6, 2024.

(51) Int. Cl. H04W 8/00; H04W 24/08; H04W 56/00

(52) U.S. Cl. CPC H04W 8/005; H04W 24/08; H04W 56/0015

(57) ABSTRACT

Methods and apparatuses for determining and implementing energizing and scanning patterns for energizing radio frequency (RF) battery-less tags. A method performed by a device configured to operate in one or more energizing and scanning (ES) states includes determining an ES state, from the one or more ES states, in which to operate the device. When the determined ES state is an energizing ES state, the method further includes transmitting an energizing signal to RF tags located in proximity to the device. When the determined ES state is a scanning ES state, the method further includes receiving signals from the RF tags.

### CROSS-REFERENCE TO RELATED AND CLAIM OF PRIORITY

The present application claims priority under 35 U.S.C. § 119(e) to U.S. Provisional Patent Application No. 63/717,141 filed on Nov. 6, 2024, which is hereby incorporated by reference in its entirety.

### TECHNICAL FIELD

The present disclosure relates generally to wireless communication systems and, more specifically, the present disclosure is related to methods and apparatuses for determining and implementing energizing and scanning patterns for energizing radio frequency (RF) battery-less tags.

### BACKGROUND

Short-range wireless communication using battery-less RF devices (referred to as tags) is becoming increasingly prevalent among a wide range of industries. Due to their low-cost, easy deployment, and battery-less nature, these tags are useful for, among other things, RF-based positioning, proximity detection, asset tracking, and environment monitoring. These cheap battery-less tags may be capable of harvesting RF energy from the environment and transmitting data packets once the harvested energy reaches a critical threshold. The energizing signal for these tags may be from ambient RF transmissions or from dedicated energizing transmission by a device present in the vicinity. Further, the reception of the transmission from these tags may be by the same or different device present in the vicinity and configured for reception.

### SUMMARY

The present disclosure relates to methods and apparatuses for determining and implementing energizing and scanning patterns for energizing RF battery-less tags.

In one embodiment, a method performed by a device configured to operate in one or more energizing and scanning (ES) states is provided. The method includes determining an ES state, from the one or more ES states, in which to operate the device. When the determined ES state is an energizing ES state, the method further includes transmitting an energizing signal to RF tags located in proximity to the device. When the determined ES state is a scanning ES state, the method further includes receiving signals from the RF tags.

In another embodiment, a device configured to operate in one or more energizing and scanning (ES) states is provided. The device includes a transceiver and a processor operably coupled to the transceiver. The processor configured to determine an ES state, from the one or more ES states, in which to operate the device. When the determined ES state is an energizing ES state, the transceiver is configured to transmit an energizing signal to radio frequency (RF) tags located in proximity to the device. When the determined ES state is a scanning ES state, the transceiver is configured to receive signals from the RF tags.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point according to various embodiments of the present disclosure;

FIG. 2B illustrates an example electronic device according to various embodiments of this disclosure;

FIG. 3 illustrates an example RF tag according to various embodiments of the present disclosure;

FIG. 4 illustrates an example energizing and scanning pattern and its associated ES state parameters, according to various embodiments of the present disclosure;

FIG. 5 illustrates example energizing and scanning patterns and their associated ES state parameters that are selected for synchronization across different devices, according to various embodiments of the present disclosure;

FIG. 6 illustrates a diagram of an ES state transition algorithm, according to various embodiments of the present disclosure;

FIGS. 7-13 illustrate diagrams of ES state transition examples, according to various embodiments of the present disclosure; and

FIG. 14 illustrates an example method performed by a station in a wireless communication system, according to various embodiments of the present disclosure.

### DETAILED DESCRIPTION

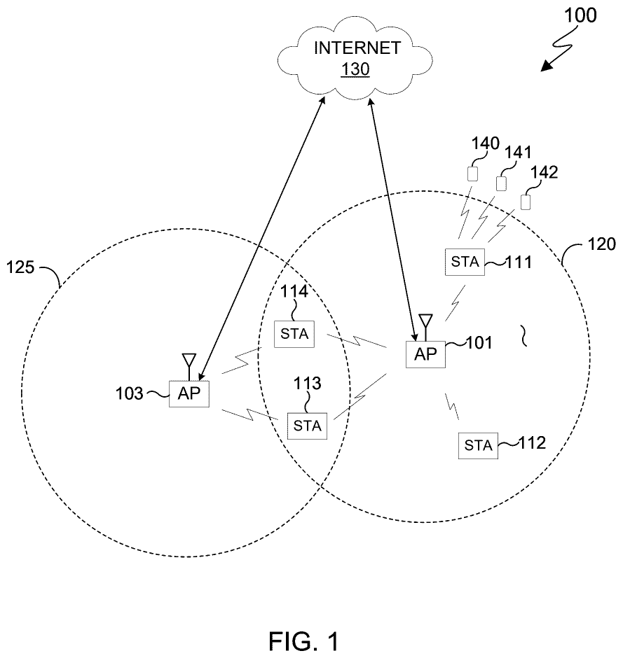

FIGS. 1-14 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The present disclosure relates to a wireless communication system, and more particularly, to a Wireless Local Area Network (WLAN) technology. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

As introduced above, wireless communication using battery-less RF devices or tags is growing in popularity among various industries. Such tags are often inexpensive, battery-less, and may have a small “sticker-like” form factor of less than 5×5 cm. Battery-less RF tags may be capable of harvesting RF energy from the environment and transmitting data packets once the harvested energy reaches a critical threshold. Such data packet transmissions are often in the 2.4 GHz Wi-Fi or 2.4 GHz Bluetooth protocols, although any suitable wireless protocol may be used. Further, battery-less RF tags may be configured with sensors capable of monitoring their surroundings, and their data packet transmissions may include this sensed information.

In several use cases, smart-phones or user-held devices may transmit dedicated energizing signals to energize battery-less RF tags. However, using dedicated energizing transmissions from a wireless device to energize battery-less RF tags can lead to several issues. Firstly, the power consumption of the wireless device rises, leading to heat and a shorter battery-life. Secondly, the channel occupancy and ambient interference in the environment increases, degrading throughput of other applications sharing the same wireless band.

In addition, smart-phones or user-held devices may scan for transmissions from battery-less RF tags. However, embodiments of the present disclosure recognize and take into consideration that scanning operations by a wireless devices may also lead to several issues. Firstly, the power consumption of the wireless device rises, leading to heat and a shorter battery-life. Secondly, the scanning operations may reserve on-device hardware, such that it cannot be used for other applications. Energizing/scanning functionality may not always be required from the wireless device, and over implementing these operations can lead to resource wastage.

Accordingly, the present disclosure provides methods and apparatuses for determining and implementing energizing and scanning patterns for energizing battery-less RF tags. As described herein, the present disclosure includes mechanisms for an RF device to determine the appropriate energizing and scanning parameters to enable operation with battery-less RF tags, while minimizing resource wastage. More particularly, various embodiments of the present disclosure provides methods and apparatuses for determining different energizing and scanning states in which an RF device is operating and one or more parameters associated therewith; methods and apparatuses for determining a scanning window pattern in relation to an energizing window pattern to increase the probability of data packet reception; and an algorithm for the RF device to switch between the different energizing and scanning states based on device conditions and the one or more associated parameters.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111, 112, 113, and 114 within a coverage area 120 of the AP 101. The APs 101-103 may communicate with each other and with the STAs 111-114 using Wi-Fi, Ultra-Wide Band (UWB), or other WLAN communication techniques. The STAs 111-114 (e.g., STA 111) may communicate with RF tags 140-142 using RF communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating energizing and/or scanning window patterns implemented by the STAs for the RF tags. Although FIG. 1 illustrates one example of a wireless network 100, various changes may be made to FIG. 1. For example, the wireless network 100 could include any number of APs, any number of STAs, and any number of RF tags in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

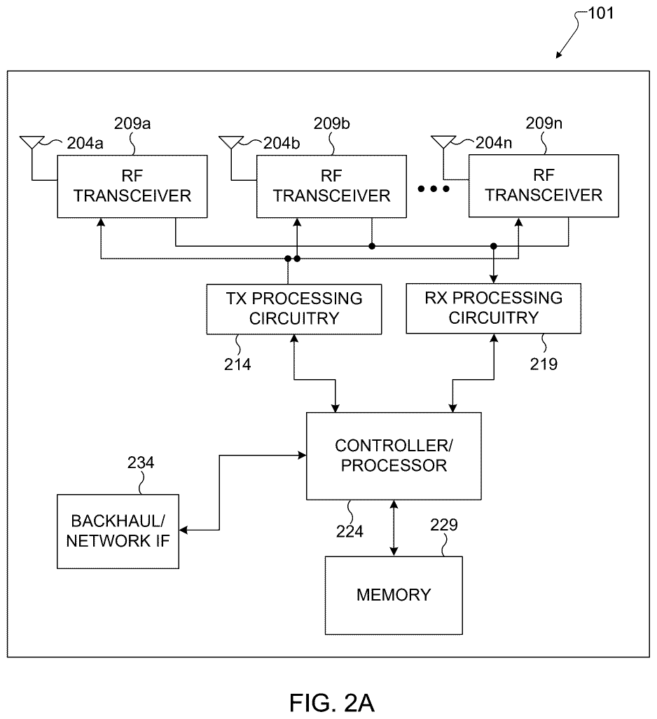

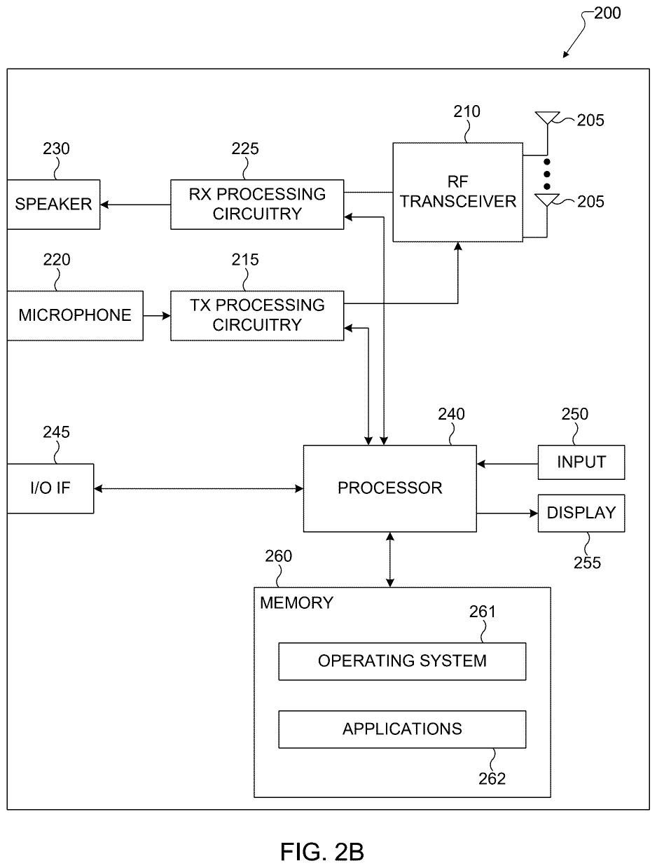

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of the present disclosure to any particular implementation of an AP.

As shown in FIG. 2A, the AP 101 includes multiple antennas 204a-204n, multiple RF transceivers 209a-209n, transmitter processing circuitry 214, and receiver processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the receiver processing circuitry 219, which generates processed baseband signals by filtering, decoding, and/or digitizing the baseband or IF signals. The receiver processing circuitry 219 transmits the processed baseband signals to the controller/processor 224 for further processing.

The transmitter processing circuitry 214 receives analog or digital data (such as voice data, web data, e-mail, or interactive video game data) from the controller/processor 224. The transmitter processing circuitry 214 encodes, multiplexes, and/or digitizes the outgoing baseband data to generate processed baseband or IF signals. The RF transceivers 209a-209n receive the outgoing processed baseband or IF signals from the transmitter processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the receiver processing circuitry 219, and the transmitter processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating energizing and/or scanning window patterns implemented by the STAs for the RF tags. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

The AP 101 may include circuitry and/or programming for facilitating energizing and/or scanning window patterns implemented by the STAs for the RF tags. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of transmitter processing circuitry 214 and a single instance of receiver processing circuitry 219, the AP 101 could include multiple instances of each (such as one per RF transceiver). Alternatively, only one antenna and RF transceiver path may be included, such as in other APs. Also, various components in FIG. 2A could be combined, further subdivided, or omitted and additional components could be added according to particular needs.

FIG. 2B illustrates an example electronic device 200 according to various embodiments of this disclosure. The embodiment of the electronic device 200 illustrated in FIG. 2B is for illustration only. However, electronic devices come in a wide variety of configurations, and FIG. 2B does not limit the scope of the present disclosure to any particular implementation of an electronic device.

The electronic device 200 includes antenna(s) 205, a radio frequency (RF) transceiver 210, transmitter processing circuitry 215, a microphone 220, and receiver processing circuitry 225. The electronic device 200 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the receiver processing circuitry 225, which generates a processed baseband signal by filtering, decoding, and/or digitizing the baseband or IF signal. The receiver processing circuitry 225 transmits the processed baseband signal to the speaker 230 (such as for voice data) or to the controller/processor 240 for further processing (such as for web browsing data).

The transmitter processing circuitry 215 receives analog or digital voice data from the microphone 220 or other outgoing baseband data (such as web data, e-mail, or interactive video game data) from the controller/processor 240. The transmitter processing circuitry 215 encodes, multiplexes, and/or digitizes the outgoing baseband data to generate a processed baseband or IF signal. The RF transceiver 210 receives the outgoing processed baseband or IF signal from the transmitter processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the electronic device 200. In one such operation, the main controller/processor 240 controls the reception of forward channel signals and the transmission of reverse channel signals by the RF transceiver 210, the receiver processing circuitry 225, and the transmitter processing circuitry 215 in accordance with well-known principles. In some embodiments, the controller/processor 240 includes at least one microprocessor or microcontroller.

The controller/processor 240 is also capable of executing other processes and programs resident in the memory 260, such as operations for determining a position of a tag based on anchor signals. The controller/processor 240 can move data into or out of the memory 260 as required by an executing process. In some embodiments, the controller/processor 240 is configured to execute a plurality of applications 262. The controller/processor 240 can operate the plurality of applications 262 based on the OS program 261 or in response to a signal received from an AP. The main controller/processor 240 is also coupled to the I/O interface 245, which provides electronic device 200 with the ability to connect to other devices such as laptop computers and handheld computers. The I/O interface 245 is the communication path between these accessories and the main controller 240.

The controller/processor 240 is also coupled to the touchscreen 250 and the display 255. The operator of the electronic device 200 can use the touchscreen 250 to enter data into the electronic device 200. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

As described in more detail below, the electronic device 200 may include circuitry and/or programming for implementing energizing and/or scanning window patterns for RF tags. For example, the electronic device 200 may be a STA such as one of STAs 111-114, a user device such as a mobile phone or tablet, a smart home appliance, a smart home hub device, a wireless base station, an access point, or any other device to provide energizing and/or scanning of RF tags in a wireless network. Although FIG. 2B illustrates one example of an electronic device, various changes may be made to FIG. 2B. For example, various components in FIG. 2B could be combined, further subdivided, or omitted and additional components could be added according to particular needs. In particular examples, the electronic device 200 may include any number of antenna(s) 205 for MIMO communication with an AP 101. In another example, the electronic device 200 may not include voice communication, an input, and/or display or the controller/processor 240 could be divided into multiple processors, such as one or more central processing units (CPUs) and one or more graphics processing units (GPUs). Also, while FIG. 2B illustrates the electronic device 200 configured as a mobile telephone or smartphone, electronic devices could be configured to operate as other types of mobile or stationary devices.

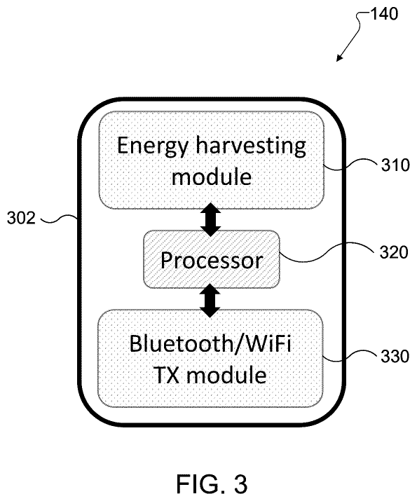

FIG. 3 illustrates an example RF tag 140 according to various embodiments of the present disclosure. The embodiment of the RF tag 140 illustrated in FIG. 3 is for illustration only, and the RF tags 140-142 of FIG. 1 could have the same or similar configuration. However, RF tags come in a wide variety of configurations, and FIG. 3 does not limit the scope of the present disclosure to any particular implementation of an RF tag.

As shown in FIG. 3, the RF tag 140 may include a tag body 302 that houses an energy harvesting module 310, at least one processor 320, and a communication module 330.

The tag body 302 may be a physical enclosure that holds and protects all the components of the RF tag 140 from moisture, abrasion, or other potentially damaging external forces. The tag body 302 may be any suitable material or substrate such as, without limitation, a glass reinforced epoxy laminate (FR-4), polyethylene terephthalate (PET), polyimide (PI), or the like. The tag body 302 may include mounting features such as, without limitation, an adhesive layer that allows the RF tag 140 to be easily attached to any stationary or moving object such as, without limitation, walls, household items, commercial inventory, or the like.

The energy harvesting module 310 is capable of harvesting ambient RF transmissions or dedicated energizing transmissions from a wireless device present in the vicinity (e.g., electronic device 200). The harvested energy may be converted into a DC voltage which in turn may be used by the other components of the RF tag 140. The energy harvesting module 310 includes at least one rectifier for converting RF energy into DC energy and at least one capacitor for storing the energy. Once the harvested energy reaches a critical threshold value, the RF tag 140 may be activated to perform its designed task. sense surrounding environmental data and/or transmit certain data packets.

The at least one processor 320 may be a lower-power microprocessor or microcontroller, an application specific integrated circuit (ASIC), or logic circuitry powered by the energy harvesting module 310. The at least one processor 320 may control the overall operation of the RF tag 140 including sensing operations and/or data packet transmission operations. Sensing operations include sensing surrounding environmental data via one or more sensors (not illustrated) that may be incorporated into the RF tag 140. Surrounding environmental data may include, without limitation, temperature, humidity, pressure, lighting, sound, vibration, or other physical parameters. Data packet transmission may include transmitting identification information or any of the sensed information obtained by the one or more sensors.

The communication module 330 may be a Bluetooth or Wi-Fi transmission module capable of transmitting the data packets which may be Bluetooth packets or Wi-Fi packets or cellular-standard (3GPP)-compliant packets. The communication module 330 may use backscatter techniques to transmit the data packets. The data packet transmissions may be in the 2.4 GHz Wi-Fi or 2.4 GHz Bluetooth protocols, although other suitable protocols may be utilized. Further, these data packets may be transmitted on a specific pre-determined wireless channel, such a Bluetooth channel 37. It may be assumed that electronic device 200 is capable of receiving the wireless signal emitted by the RF tag 140.

The RF tag 140 may include circuitry and/or programming for utilizing energizing and/or scanning window patterns implemented by the STAs. Although FIG. 3 illustrates one example of RF tag 140, various changes may be made to FIG. 3. For example, various components in FIG. 3 could be combined, further subdivided, or omitted and additional components could be added according to particular needs.

As set forth above, the present disclosure provides mechanisms for an RF device to determine the appropriate energizing and scanning parameters to enable operation with battery-less RF tags, while minimizing resource wastage.

For instance, in the present disclosure various energizing states are provided.

In some embodiments, a device may operate in one or more states, with respect to its tag energizing behavior. A few examples of the different energizing states can be: Q No energizing state: The device does not transmit any signals for the purpose of energizing. Q Low energizing state: The device transmits energizing signals sporadically. For example, the duty cycle of the energizing can be much less than 1. The power consumption in this state may be lower. This can be, for example, to identify presence of at least one tag. Q High energizing state: The device transmits energizing signals aggressively/frequently. For example, the duty cycle of the scanning can be high. The power consumption in this state may be lower.

Note that in a few variants, some of these states may be missing or they may be combined together into a common state. In another variant, there may also be multiple energizing states between low and high energizing.

In the present disclosure, various scanning states are also provided.

In other embodiments, a device may operate in one or more states, with respect to its tag scanning behavior. A few examples of the different scanning states can be:
No scanning state: The device does not scan for transmissions from tags.
Low scanning state: The device scans for tag transmissions sporadically. For example, the duty cycle of the scanning can be much less than 1. The power consumption in this state may be lower.
High scanning state: The device scans for tag transmissions aggressively/frequently. For example, the duty cycle of the scanning can be high. The power consumption in this state may be higher.

Note that in a few variants, some of these states may be missing or they may be combined together into a common state. In another variant, there may also be multiple scanning states between low and high scanning.

In the present disclosure, various energizing and scanning states are also provided.

In one embodiment, the device may exist in any combination of energizing and scanning state. In another embodiment, for each energizing state there may only be a subset of scanning states available, or vice versa. Without loss of generality, there can be a joint energizing and scanning (ES) state defined, which corresponds to a combination of energizing and scanning states.

In the present disclosure, various parameters of ES states are provided.

In various embodiments, each ES state may be associated with one or more parameters, including:
Maximum energizing power.
Energizing duration.
Energizing interval.
The operating frequency of energizing signal.
The transmission protocol for the energizing signal.
Scanning duration.
Scanning interval.
Scanning frequency/channel set.
Time spent in ES state.

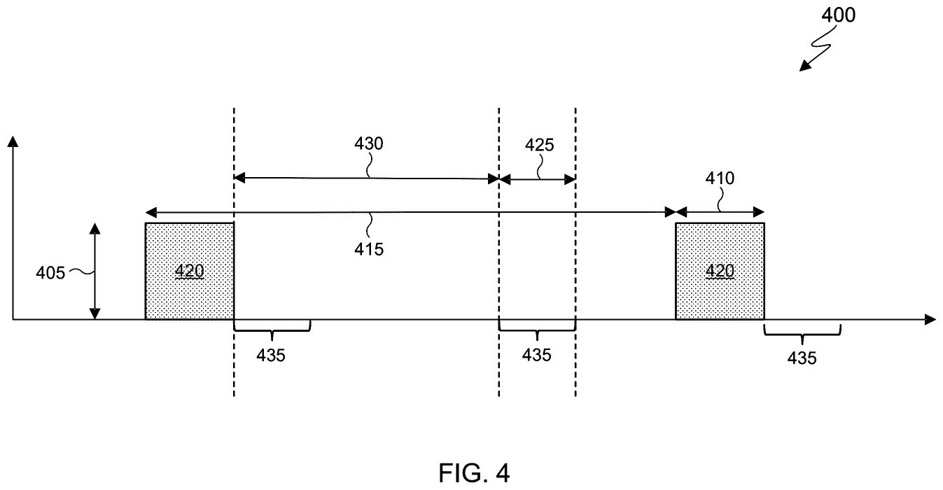

FIG. 4 illustrates an example energizing and scanning pattern 400 and its associated ES state parameters, according to various embodiments of the present disclosure. The embodiment of the energizing and scanning pattern 400 shown in FIG. 4 is for illustration only. Other embodiments of the energizing and scanning pattern 400 could be used without departing from the scope of the present disclosure.

As shown in FIG. 4, the example energizing and scanning pattern 400 has one or more associated ES state parameters including a max energizing power 405, an energizing duration 410, and an energizing interval 415, thus resulting in an energizing windows 420. Further, the one or more associated ES state parameters include a scanning duration 425 and a scanning interval 430, thus resulting in a scanning windows 435.

In various embodiments, the parameters for each ES state can be pre-configured to the device, or sent to the device by a second device. In some embodiments where the channel access is contention based, all or some of the above parameters may be “approximate” or “desired” values, which may experience variation due to contention.

In one embodiment, the maximum energizing power may be selected to meet spectrum emission regulations.

In one embodiment, the operating frequency of scanning and energizing may be selected such that the device is capable of energizing and scanning at the same time, without self-interference.

In one embodiment, the power consumption of an ES state can be determined using the different ES parameters. For example, in one embodiment, the power consumption can be computed as:

$${P}_{E S} = {P}_{s c a n} \times \frac{ScanDuration}{ScanInterval} + {P}_{energize} \times \frac{EnergizingDuration}{EnergizingInterval} + {P}_{i dle} ,$$

where P_{scan} is the power consumption when performing scanning, P_{energize} is the power spend during energizing (which is a function of max. energizing power), and P_{idle} is the power consumed by device for other operations (excluding energizing and scanning).

In the present disclosure, the ability to select various transmission/scanning windows is provided.

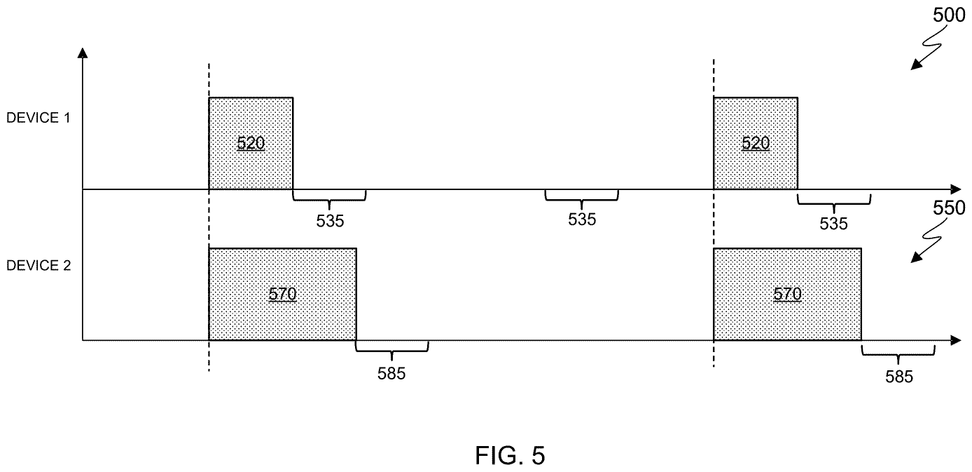

FIG. 5 illustrates example energizing and scanning patterns 500 and 550 and their associated ES state parameters that are selected for synchronization across different devices, according to various embodiments of the present disclosure. The embodiments of the energizing and scanning patterns 500 and 550 shown in FIG. 5 are for illustration only. Other embodiments of the energizing and scanning patterns 500 and 550 could be used without departing from the scope of the present disclosure.

As shown in FIG. 5, the example energizing and scanning pattern 500 for a first device has one or more associated ES state parameters including a pre-configured max energizing power, energizing duration, and energizing interval, resulting in an energizing windows 520. Further, the one or more associated ES state parameters include a pre-configured scanning duration and scanning interval, resulting in scanning windows 535. As further shown in FIG. 5, the example energizing and scanning pattern 550 for a second device has one or more associated ES state parameters including a pre-configured max energizing power, energizing duration, and energizing interval, resulting in energizing windows 570. Further, the one or more associated ES state parameters include a pre-configured scanning duration and scanning interval, resulting in scanning windows 585.

In such embodiments, the energizing windows 520 and 570 and/or scanning windows 535 and 585 may be synchronized to a clock/timer. The clock/timer can be the device clock, or can be a clock/timer obtained from a second device, such as an access point (AP) or soft AP. This can be, for example, to synchronize the energizing and scanning operations of multiple devices present in the vicinity. In one example, all devices may have the same energizing start time and same energizing interval, to make sure that all energizing operations overlap each other, as illustrated in FIG. 5.

In one embodiment, when a device is performing energizing, it may be incapable of performing scanning at the same time. This can happen, for example, if the two operations use the same antenna front end. So, in one embodiment, the energizing windows and scanning windows may be jointly selected. For example, the scanning window may be selected to avoid an energizing window and thereby avoid self-interference from the energizing operation. In another example, the scanning window may follow immediately after an energizing window, where the chance of tag transmissions is high, as illustrated in FIG. 5.

In the present disclosure, various ES state transitions are provided.

In one embodiment, the wireless device may transition between the different ES states based on one or more triggering conditions. The transitions may be defined for all or a subset of the pairs of states. The triggering condition for transition from an ES state A to an ES state B may be based on one or more of:
Device capability of energizing.
The current energizing-scanning state (A) and its parameters.
The target energizing-scanning state (B) and its parameters.
Signaling received from an application: There may be an application that may request a certain transition.
Location context of the user: Obtained using GPS, association with specific APs, etc.
Proximity context of user: User device being in a certain range around another device.
Current battery state of the user device
Current temperature level of the user device.
Requirements of other applications/features using same hardware: Example Wi-Fi traffic QoS requirements.
Observation of specific triggering signal on the wireless medium.
Channel occupancy in one or more Wi-Fi or BLE channels.
Average transmission power in one or more Wi-Fi or BLE channels.
Number of tag transmissions observed in a previous time window.
Identifiers of the tags from which packets have been received within a certain time interval.
Time spent in current energizing-scanning state (A).
The mobility context of the user: Obtained using inertial motion unit sensor, etc. For example, user is stationary or moving.
The visual context of the user: Obtained using a camera on the device.

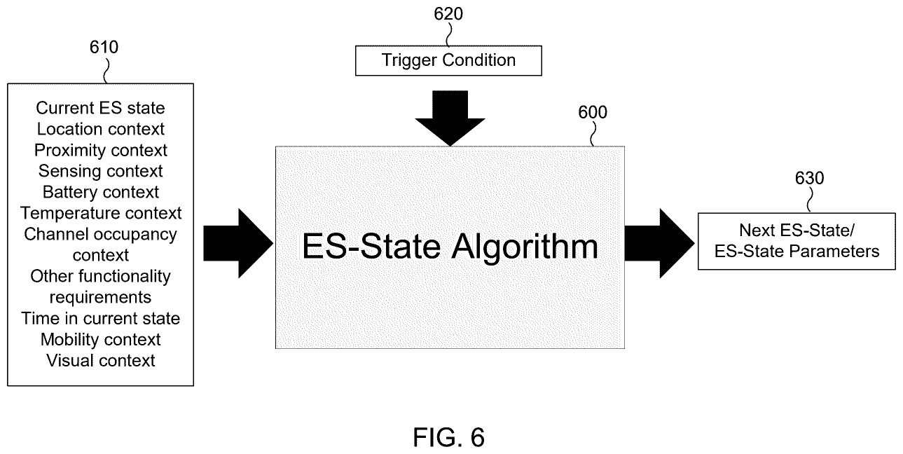

FIG. 6 illustrates a diagram of an ES state transition algorithm 600, according to various embodiments of the present disclosure. The embodiment of the ES state transition algorithm 600 shown in FIG. 6 is for illustration only. Other embodiments of the ES state transition algorithm 600 could be used without departing from the scope of the present disclosure.

As shown in FIG. 6, the trigger conditions can be implemented as algorithm 600, which can be run by the device. The algorithm 600 can take current ES state and several parameters 610 (that influence trigger conditions 620) as input, and can generate the next ES state 630 to be used. In a variant, the parameters for next ES state can also be generated by the algorithm 600. The algorithm 600 can be run periodically or upon trigger by another method, as discussed above. In a variant, the algorithm 600 may be implemented on a second device or in the cloud. Correspondingly, upon receiving a trigger condition 620 the device may forward the algorithm input parameters 610 to the second device or to the cloud to obtain, in response, the next ES state and corresponding parameters 630.

In various embodiments, some examples of conditions for transition to higher energizing state:
A user opens an application and/or presses a button.
A user sends a specific voice command to a voice assistant.
The device GPS indicates presence in a region, where energizing is pre-configured.
The device moves into range or associates with a specific Wi-Fi access point, for which energizing is pre-configured.
Some packets from the tags are observed during the scanning operation.
Demands of other device functionalities that share resources with energizing are reduced, e.g., Wi-Fi or BLE performance.
The observed ambient RF energy in the medium or channel occupancy is lower than a threshold.
User is identified as moving with a speed above a threshold, e.g., using IMU information.
User visual feed from camera indicates moving into an area with tags.

In various embodiments, some examples of conditions for transition to lower energizing state:
A user closes an application and/or presses a button.
A user sends a specific voice command to a voice assistant.
The device GPS indicates moving away from regions where energizing is pre-configured.
The device disassociates or moves out of range of a Wi-Fi access points for which energizing is pre-configured.
The device battery-life reduces below a certain threshold.
No packets are observed from any tag within a certain time interval.
No packets are observed from any “new tag” within a certain time interval, compared to a list of tags already observed within a previous time interval.
Demands of other device functionalities that share resources with energizing are increased, e.g., Wi-Fi or BLE performance.
The observed ambient RF energy in the medium or channel occupancy is higher than a threshold.
User is identified as moving with a speed below a threshold, e.g., using IMU information.
User visual feed from camera indicates moving away from an area with tags.

In various embodiments, some examples of conditions for transition to higher scanning state:
A user opens a find-my-device application and/or presses a button.
A user sends a specific voice command to a voice assistant.
The device GPS indicates presence in a region, where scanning is pre-configured.
The device moves into range or associates with a specific Wi-Fi access point, for which scanning is pre-configured.
Some packets from the tags are observed during the scanning operation.
Demands of other device functionalities that share resources with scanning are reduced, e.g., Wi-Fi or BLE performance.
The number of packets observed is lower than a threshold, where the threshold may be dependent on the energizing state.
User is identified as moving with a speed above a threshold, e.g., using IMU information.
User visual feed from camera indicates moving into an area with tags.

In various embodiments, some examples of conditions for transition to lower scanning state:
A user closes a find-my-device application and/or presses a button.
A user sends a specific voice command to a voice assistant.
The device GPS indicates moving away from regions where scanning is pre-configured.
The device disassociates or moves out of range of a Wi-Fi access points for which scanning is pre-configured.
The device battery-life reduces below a certain threshold.
No packets are observed from any tag within a certain time interval.
No packets are observed from any “new tag” within a certain time interval, compared to a list of tags already observed within a previous time interval.
Demands of other device functionalities that share resources with scanning are reduced, e.g., Wi-Fi or BLE performance.
The number of packets observed is above than a threshold, where the threshold may be dependent on the energizing state.
User is identified as moving with a speed below a threshold, e.g., using IMU information.
User visual feed from camera indicates moving away from an area with tags.

In the present disclosure, various examples of ES state transitions are provided.

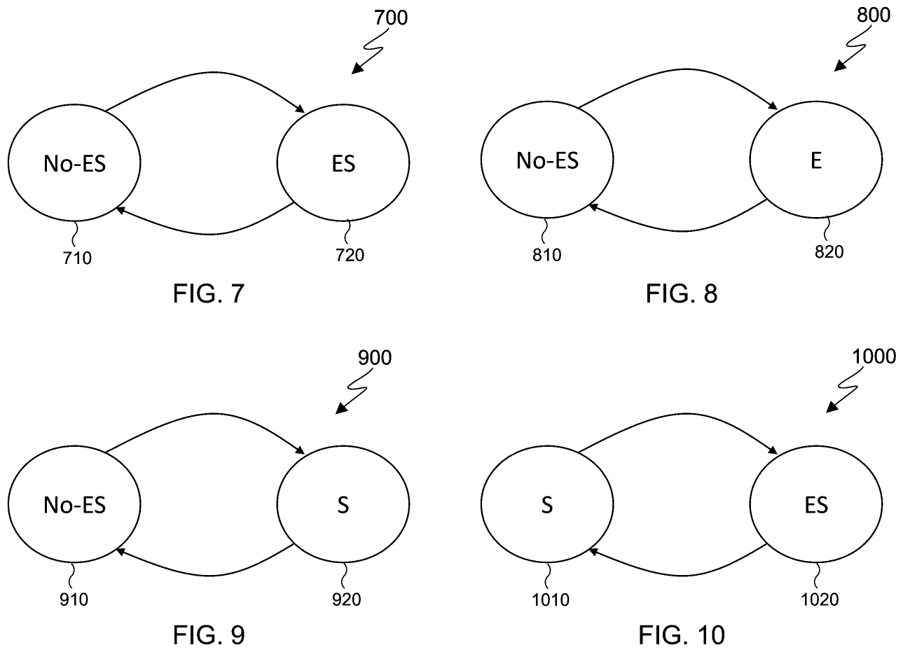

FIGS. 7-13 illustrate diagrams of ES state transition examples 700-1300, according to various embodiments of the present disclosure. The embodiments of the ES state transitions 700-1300 shown in FIGS. 7-13 are for illustration only. Other embodiments of the ES state transitions 700-1300 could be used without departing from the scope of the present disclosure.

In ES state transition example 700, as illustrated in FIG. 7, the device has two ES states:
No-ES: the device performs neither energizing nor scanning
ES: the device performs both energizing and scanning.

The device normally operates in no-ES state 710 to save power. The device transitions from no-ES 710 to ES state 720 based on some trigger conditions:
The user opens a certain application or the phone receives a command from a certain application.
The user walks into proximity of another companion device, such as a transporting cart/van.

An additional condition on the user location may also be imposed. The device transitions back from ES state 720 to no-ES 710 state based on some trigger conditions:
The user closes a certain application or the phone receives a command from a certain application.
A certain time has elapsed since the user has entered the ES state 720.
The user walks out of proximity of a companion device.
The user device battery is drained below a certain level.

In ES state transition example 800, as illustrated in FIG. 8, the device has two ES states:
No-ES: the device performs neither energizing nor scanning
E: the device performs energizing but not scanning.

In this example the goal of the device may be to energize the tags but not scan the transmissions from them. The scanning may be performed by a separate device. The device normally operates in no-ES state 810 to save power. It transitions from no-ES state 810 to E state 820 based on some trigger conditions:
The user opens a certain application or the phone receives a command from a certain application.
The user has entered a certain location.

The device transitions from E state 820 to no-ES state 810 based on some trigger conditions:
The user closes a certain application or the phone receives a command from a certain application.
A certain time has elapsed since the user has entered the E state 820.
The user device battery is drained below a certain level.

In ES state transition example 900, as illustrated in FIG. 9, the device has two ES states:
No-ES: the device performs neither energizing nor scanning
S: the device performs scanning but not energizing.

In this example the goal of the device may be to scan for the transmissions from the tags but not energize the tags. The energizing may be performed by a separate device. The device normally operates in no-ES 910 state to save power. The device transitions from no-ES state 910 to S state 920 based on some trigger conditions:
The user opens a certain application or the phone receives a command from a certain application.
The user has entered a certain location.

The device transitions from S state 920 to no-ES state 910 based on some trigger conditions:
The user closes a certain application or the phone receives a command from a certain application.
Some packets are observed from the tags within a certain time window.
A certain time has elapsed since the user has entered the S state 920.
The user device battery is drained below a certain level.

In ES state transition example 1000, as illustrated in FIG. 10, the device has two ES states:
S: the device performs scanning but no energizing.
ES: the device performs both energizing and scanning.

The device normally operates in S state 1010 to save power. The device transitions from S state 1010 to ES state 1020 based on some trigger conditions:
The user opens a certain application or the phone receives a command from a certain application.
Some packets are observed from the tags within a certain time window.

An additional condition on the user location may also be imposed. It transitions from ES state 1020 to S 1010 state based on some trigger conditions:
The user closes a certain application or the phone receives a command from a certain application.
A certain time has elapsed since the user has entered the ES state 1020.
The user device battery is drained below a certain level.

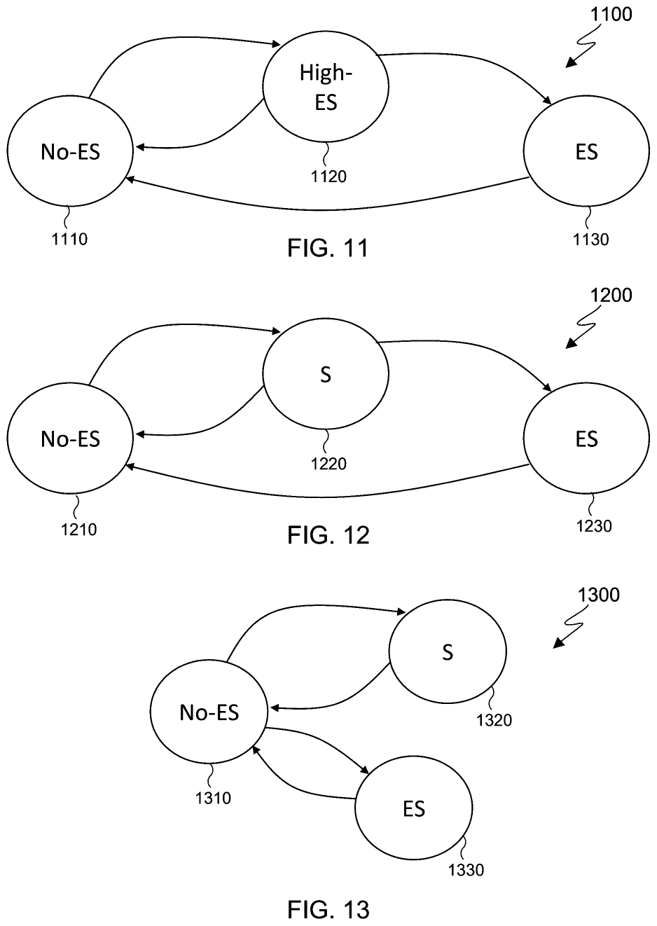

In ES state transition example 1100, as illustrated in FIG. 11, the device has three ES states:
No-ES: the device performs neither energizing nor scanning
ES: the device performs both energizing and scanning with a low duty cycle.
High-ES: the device performs both energizing and scanning with a high duty cycle.

The device normally operates in no-ES state 1110 to save power. It transitions from no-ES state 1110 to high-ES state 1120 based on some trigger conditions:
The user opens a certain application or the phone receives a command from a certain application.
The user has moved into a certain location.

This can be to reduce the latency to first packet reception and quick determination of if tags are present. The device transitions from high-ES state 1120 to ES state 1130 if some packets from tags are observed in current state and/or a certain time has elapsed while operating in high-ES state 1120. The device transitions from high-ES state 1120 to no-ES state 1110 if no packets from tags are observed in current state. The device transitions from ES state 1130 to no-ES state 1110 based on some trigger conditions:
The user closes a certain application or the phone receives a command from a certain application.
The user device battery is drained below a second threshold.
The user has moved out of a certain area or location.

In ES state transition example 1200, as illustrated in FIG. 12, the device has three ES states:
No-ES: the device performs neither energizing nor scanning.
S: the device performs scanning but no energizing.
ES: the device performs both energizing and scanning.

The device normally operates in no-ES state 1210 to save power. It transitions from no-ES state 1210 to S state 1220 when the user opens a certain application or the phone receives a command from a certain application. An additional condition on the user location may also be imposed. The device transitions from S state 1220 to ES state 1230 based on some trigger conditions:
Some packets from tags are observed in the S state 1220.
The packet rate from the tags is below a first threshold.

The device transitions from S state 1220 to no-ES state 1210 if no packets from tags are observed in the S state 1220. The device transitions from ES state 1230 to S state 1220 based on some trigger conditions:
The user device battery is drained below a second threshold.
The ambient RF energy and/or observed packet rate are higher than a third threshold.

It transitions from ES state 1230 to no-ES state 1210 based on some trigger conditions:
The user closes a certain application or the phone receives a command from a certain application.
The user device battery is drained below a fourth threshold.
The user has moved out of a certain area or location.

In one example use case, a user may intend to pick up an asset that has a tag placed on it and deliver it to a target location. By obtaining information about the asset from the tag transmission, the determination of the target location may be obtained. The user may carry a device to help with the process. In this ES state transition example 1300, as illustrated in FIG. 13, the device may have three ES states:
No-ES: the device performs neither energizing nor scanning
S: the device performs scanning but no energizing.
ES: the device performs both energizing and scanning.

The user device may normally operate in a no-ES state 1310 by default. However, when the user enters an area designated for asset storage and/or asset drop off, his device may either:
transition to S state 1320 if the ambient RF energy is above a threshold.
transition to ES state 1330 if the ambient RF energy is below a threshold.

After being in either the S state 1320 or the ES state 1330 for a threshold time, or upon receiving at least a threshold number of packets from one or more tags (which help resolve the target location for the asset), the device may transition back to the no-ES state 1310.

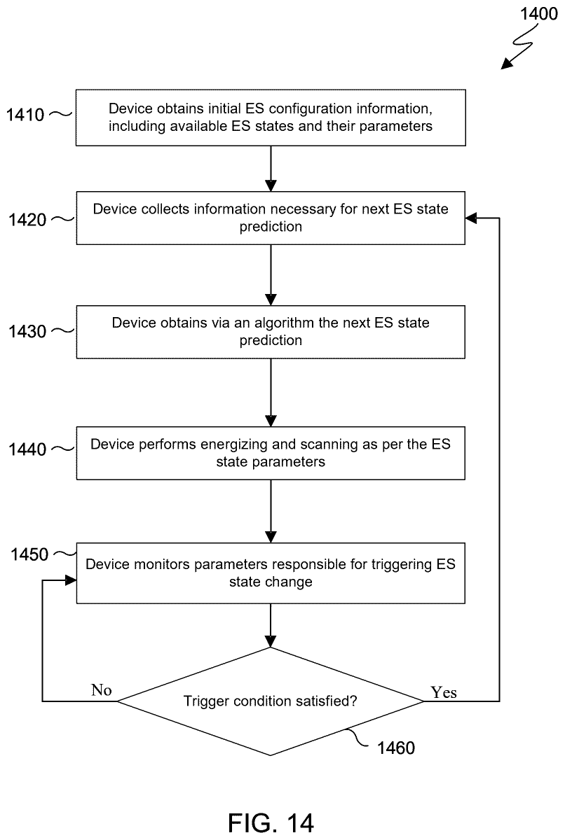

FIG. 14 illustrates an example method 1400 performed by an STA in a wireless communication system according to embodiments of the present disclosure. The method 1400 of FIG. 14 can be performed by any of the STAs 111-114 of FIG. 1, such as the electronic device 200 of FIG. 2B. The method 1400 is for illustration only and other embodiments can be used without departing from the scope of the present disclosure.

The method 1400 is a sequence of steps performed by a device for energizing and scanning the battery-less RF tags. The method 1400 begins at 1410, where a device obtains initial ES configuration information, including available ES states and their parameters. Then at 1420, the device collects information necessary for next ES state prediction. Then at 1430, the device obtains via an algorithm the next ES state prediction. Then at 1440, the device performs energizing and scanning as per the ES state parameters. Then at 1450, the device monitors parameters responsible for triggering ES state change. If the trigger condition is satisfied, at 1460, the method 1400 proceeds back 1420. If the trigger condition is not satisfied, at 1460, the method proceeds back to 1450.

Although FIG. 14 illustrates one example method performed by a device for energizing and scanning the battery-less RF tags various changes may be made to FIG. 14. For example, while shown as a series of steps, various steps in FIG. 14 may overlap, occur in parallel, occur in a different order, or occur any number of times.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method performed by a device configured to operate in one or more energizing and scanning (ES) states, the method comprising:
determining an ES state, from the one or more ES states, in which to operate the device,
wherein when the determined ES state is an energizing ES state, the method further comprises transmitting an energizing signal to radio frequency (RF) tags located in proximity to the device, and
wherein when the determined ES state is a scanning ES state, the method further comprises receiving signals from the RF tags.

2. The method of claim 1, wherein each of the one or more ES states comprises ES parameters that define:
an energizing power, start time, duration, interval, and operating frequency for transmitting the energizing signal to the RF tags, wherein the energizing power, start time, duration, and interval is represented by energizing windows; and
a scanning start time, duration, interval, and operating frequency for receiving the signals from the RF tags, wherein the scanning start time, duration, and interval is represented by scanning windows.

3. The method of claim 1, wherein when the determined ES state is an energizing and scanning ES state, the method further comprises simultaneously transmitting the energizing signal to the RF tags and receiving the signals from the RF tags, wherein transmitting the energizing signal to the RF tags and receiving the signals from the RF tags for the energizing and scanning ES state are configured to operate among different frequencies to allow for simultaneously transmitting and receiving.

4. The method of claim 2, wherein the energizing windows and the scanning windows are configured to reduce interference between the energizing signal and the signals from the RF tags and increase reception of the signals from the RF tags.

5. The method of claim 2, wherein the energizing windows, the scanning windows, or both are configured to be synchronized with energizing windows, scanning windows, or both of a second device based on an internal clock of the device, the second device, or an access point (AP) to which the device and second device are connected.

6. The method of claim 3, further comprising:
monitoring context information for the device, the context information comprising at least one selected from the group of location data, proximity data, application signaling data, battery data, reception data from the RF tags, and ES state operating time data; and
detecting whether at least one trigger condition has occurred, wherein the at least one trigger condition occurs when there is a material change in the context information,
wherein determining the ES state is based on the monitored context information and the at least one trigger condition detected.

7. The method of claim 6, further comprising:
detecting that the at least one trigger condition has occurred when an application is launched on the device or the device is moved into a predetermined area,
wherein determining the ES state comprises determining the ES state of the device to be the energizing ES state, the scanning ES state, or the energizing and scanning ES state.

8. The method of claim 6, further comprises:
detecting that the at least one trigger condition has occurred when an application is closed on the device, the device is moved out of a predetermined area, or the device receives no data packets from the RF tags,
wherein determining the ES state comprises determining the ES state of the device to be a non-energizing and non-scanning ES state, wherein no energizing signal to the RF tags is transmitted and no signals from the RF tags are received.

9. The method of claim 6, further comprising:
detecting that the at least one trigger condition has occurred when the device receives at least some data packets from the RF tags at a rate below a predetermined data packet rate threshold,
wherein determining the ES state comprises determining the ES state of the device to be the energizing and scanning ES state.

10. The method of claim 6, further comprising:
detecting that the at least one trigger condition has occurred when a battery level of the device falls below a predetermined battery level threshold and the device receives at least some data packets from the RF tags at a rate above a predetermined data packet rate threshold,
wherein determining the ES state comprises determining the ES state of the device to be a scanning ES state.

11. A device configured to operate in one or more energizing and scanning (ES) states, the device comprising:
a transceiver; and
a processor operably coupled to the transceiver, the processor configured to determine an ES state, from the one or more ES states, in which to operate the device,
wherein when the determined ES state is an energizing ES state, the transceiver is configured to transmit an energizing signal to radio frequency (RF) tags located in proximity to the device, and
wherein when the determined ES state is a scanning ES state, the transceiver is configured to receive signals from the RF tags.

12. The device of claim 11, wherein each of the one or more ES states comprises ES parameters that define:
an energizing power, start time, duration, interval, and operating frequency by which to transmit the energizing signal to the RF tags, wherein the energizing power, start time, duration, and interval is represented by energizing windows; and
a scanning start time, duration, interval, and operating frequency by which to receive the signals from the RF tags, wherein the scanning start time, duration, and interval is represented by scanning windows.

13. The device of claim 11, wherein when the determined ES state is an energizing and scanning ES state, the transceiver is configured to simultaneously transmit the energizing signal to the RF tags and receive the signals from the RF tags, wherein transmission of the energizing signal to the RF tags and reception of the signals from the RF tags for the energizing and scanning ES state are configured to operate among different frequencies to allow the device to simultaneously transmit and receive.

14. The device of claim 12, wherein the energizing windows and the scanning windows are configured to reduce interference between the energizing signal and the signals from the RF tags and increase reception of the signals from the RF tags.

15. The device of claim 12, wherein the energizing windows, the scanning windows, or both are configured to be synchronized with energizing windows, scanning windows, or both of a second device based on an internal clock of the device, the second device, or an access point (AP) to which the device and second device are connected.

16. The device of claim 13, wherein the processor is further configured to:
monitor context information for the device, the context information comprising at least one selected from the group of location data, proximity data, application signaling data, battery data, reception data from the RF tags, and ES state operating time data; and
detect whether at least one trigger condition has occurred, wherein the at least one trigger condition occurs when there is a material change in the context information, wherein the determined ES state is based on the monitored context information and the at least one trigger condition detected.

17. The device of claim 16, wherein the processor:
detects the at least one trigger condition when an application is launched on the device or the device is moved into a predetermined area; and
determines the ES state of the device to be the energizing ES state, the scanning ES state, or the energizing and scanning ES state.

18. The device of claim 16, wherein the processor:
detects the at least one trigger condition when an application is closed on the device, the device is moved out of a predetermined area, or the device receives no data packets from the RF tags; and
determines the ES state of the device to be a non-energizing and non-scanning ES state, wherein the transceiver is configured not to transmit the energizing signal to the RF tags or receive the signals from the RF tags.

19. The device of claim 16, wherein the processor:
detects the at least one trigger condition when the device receives at least some data packets from the RF tags at a rate below a predetermined data packet rate threshold; and
determines the ES state of the device to be the energizing and scanning ES state.

20. The device of claim 16, wherein the processor:
detects the at least one trigger condition when a battery level of the device falls below a predetermined battery level threshold and the device receives at least some data packets from the RF tags at a rate above a predetermined data packet rate threshold; and
determines the ES state of the device to be the scanning ES state.
